(19) United States
(12) Patent Application Publication
(10) Pub. No.: US 2010/0186024 A1
(43) Pub. Date: Jul. 22, 2010

(54) System and Method of Invoking Multiple Remote Operations

(75) Inventors: Johan Eker, Lund (SE); Jan Patrik Persson, Lund (SE); Carl von Platen, Malmo (SE)

Correspondence Address: COATS & BENNETT, PLLC, 1400 Crescent Green, Suite 300, Cary, NC, 27518, US

(73) Assignee: Telefonaktiebolaget LM Ericsson (publ), Stockholm (SE)

(21) Appl. No.: 12/357,190

(22) Filed: Jan. 21, 2009

(51) Int. Cl. G06F 9/44; G06F 13/00

(52) U.S. Cl. 719/330

(57) ABSTRACT

A remote execution agent, having low-latency access to the platform, receives from a remote application, across a communication channel imposing a round-trip delay, a plurality of invocation control directives. The remote execution agent invokes operations for execution on the platform in response to the invocation control directives, and aggregates results from the operations, returning the aggregated results to the application. In this manner, overhead such as communication round-trip delay, context switching, and the like, is reduced, compared to the application sending separate operation invocation requests to the platform and receiving the results of each. The remote execution agent manages operation results, such as passing results from a prior operation as parameters for a later one. In some embodiments, the invocation control directives include conditional operation invocation and branching.

### TECHNICAL FIELD

The present invention relates generally to computing, and in particular to a system and method of efficiently invoking multiple operations for remote execution as a group.

### BACKGROUND

Computational platforms are often controlled, at least partially, by remote applications. For example, one or more functions of a computational platform within a wireless communication network user equipment (such as a mobile radiotelephone) may be controlled by an application executing within the network. As another example, a first computational platform within a mobile terminal, such as a modem processor, may be controlled by an application executing on a main, or system, processor.

In either case, communications between the application and the processor incur a “round-trip delay,” as illustrated in FIG. 1. The application 10 transmitting requests for a first operation to the platform 12, which executes the operation and returns the results (which may simply comprise an indication of the success or failure of the operation) to the application 10. The round-trip delay may be many times greater than the operation execution time. In the example of a network application requesting operations on a computational platform in a mobile terminal, the round-trip delay may comprise primarily message travel time, including delay across the air interface, network latency, and the like. In the example of an application executing on one processor and requesting operations on a second processor, the round-trip delay may comprise primarily interrupt handling and/or context switching overhead on one or both processors. Regardless of the source of the round-trip delay, it may comprise a significant fraction of, or even exceed, the execution time of the requested operation.

When the round-trip delay is significant, but the bit-rate of the communication channel is not the limiting factor, it is beneficial to aggregate multiple remote execution requests and their results into a single communications package or unit, such as a packet. This is not possible, however, when the requested operations are inter-dependent. For example, FIG. 1 depicts the case where the request for a subsequent operation depends on the results of a prior operation. This may occur where the results of the first operation are a parameter for the second operation. Alternatively, the second operation may be conditionally requested (or not) depending on the result of the first operation. In either case, straightforward aggregation of the first and second operation requests is not possible, as the dependency cannot be expressed to the platform.

### SUMMARY

According to one or more embodiments of the present invention, a remote execution agent, having low-latency access to the platform, receives from a remote application, across a communication channel imposing a round-trip delay, a plurality of invocation control directives. The remote execution agent invokes operations for execution on the platform in response to the invocation control directives, and aggregates results from the operations, returning the aggregated results to the application.

One embodiment relates to a method of invoking a plurality of operations on a platform by a remote execution agent, under the direction of a remote application, wherein communications between the application and platform incur a round-trip delay. A plurality of invocation control directives is received from the application. A plurality of operations is invoked for execution on the platform in response to the invocation control directives. At least an indication of the results of the operations is returned to the application.

Another embodiment relates to a computing platform. The platform includes memory, a controller operative to execute operations, and a remote execution agent. The remote execution agent is operative to receive a plurality of invocation control directives from a remote application; invoke a plurality of operations for execution on the platform in response to the invocation control directives; and return at least an indication of the results of the operations to the application.

### BRIEF DESCRIPTION OF THE DRAWINGS

FIG. 1 is a message flow diagram depicting the remote invocation and execution of inter-dependent operations.

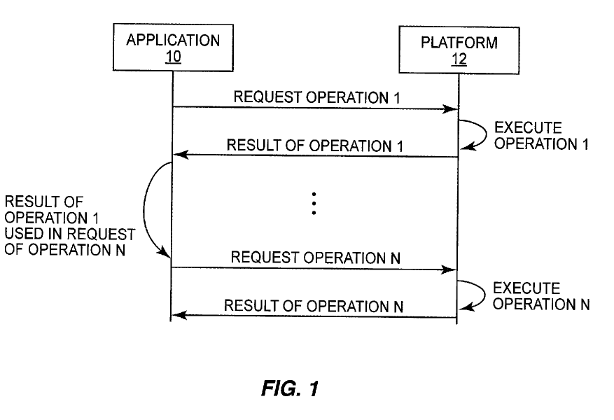

FIG. 2 is a functional block diagram depicting the remote invocation and execution of operations by a remote execution agent, according to one embodiment of the present invention.

FIG. 3 is a flow diagram of a method of performing a plurality of operations by a remote execution agent.

FIG. 4 is a representative listing of invocation control directives to read a battery status.

### DETAILED DESCRIPTION

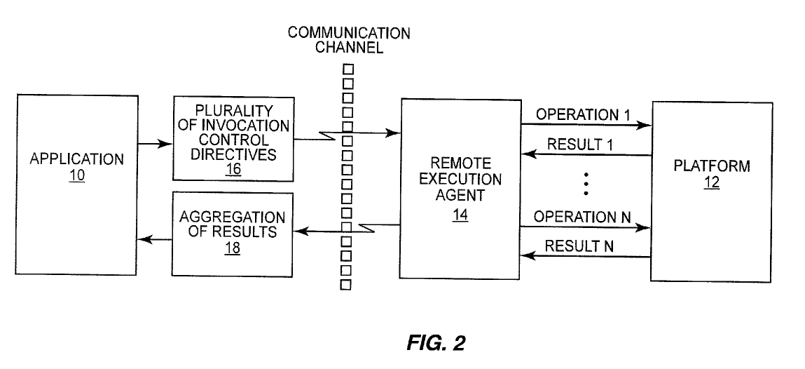

FIG. 2 is a functional block diagram depicting the execution of operations by application 10 on a remote platform 12 via a remote execution agent 14. The application 10 generates a plurality of invocation control directives 16, and transmits them to the remote execution agent 14 across a communication channel.

The invocation control directives 16 are not processor or software instructions, but are rather control directives that manipulate a data structure, such as a stack, and invoke, or call, operations to be executed on the platform 12. As used herein, operations may comprise software modules, such as function calls, subroutines, or the like. An operation may require one or more parameters, and may return one or more textual, numeric, or logical results. The invocation control directives 16 may include basic logical and flow control constructs, allowing for the detection of simple logical relationships, the conditional invocation of operations, and the passing of the results from a prior operation as parameters to a later operation.

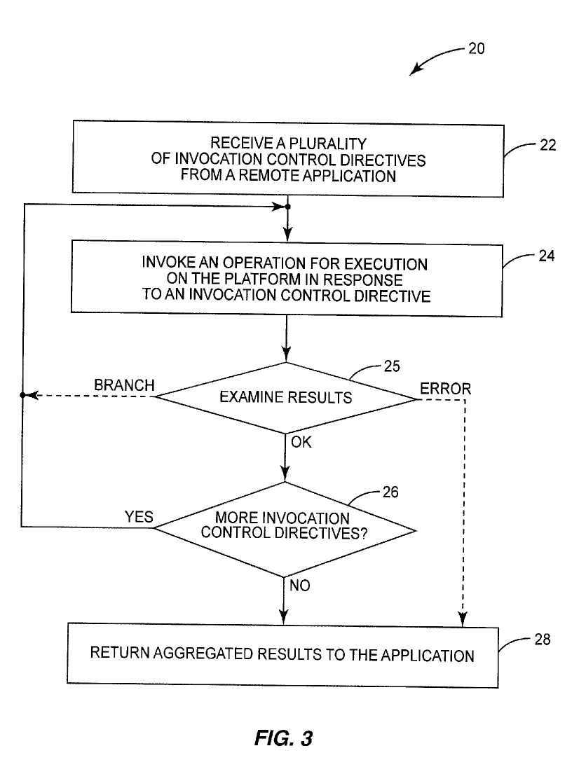

The remote execution agent 14 is a simple interpretive engine that implements control flow, invokes operations on the platform 12, and performs basic data handling such as providing parameters and receiving results. By way of comparison, the remote execution agent 14 is much simpler than a JAVA® or FORTH® interpreter. A method 20 of operation of the remote execution agent 14 is depicted in FIG. 3. The remote execution agent 14 receives a plurality of invocation control directives 16 from an application 10 (block 22). The remote execution agent 14 invokes an operation for execution on the platform 12 in response to an invocation control directive (block 24).

The results of the operation execution, received from the platform, are examined (block 25), and various actions may result. In one embodiment, if the operation execution results in an error, further processing of invocation control directives may be aborted, and the results of operations invoked this far are aggregated and returned to the application (block 28). In one embodiment, control-flow directives such as conditional operation invocation directives (described below) may cause the remote execution agent 14 to branch to a non-sequential invocation control directive, and continue processing the directives. The conditional nature of these control-flow paths is indicated in FIG. 3 with dashed lines. In most cases, if a non-control-flow directive invokes an operation on the platform that executes successfully (block 25), the remote execution agent 14 examines whether additional invocation control directives remain (block 26), and if so, executes them sequentially (block 24).

When all invocation control directives in the plurality 16 have been processed (block 26), the remote execution agent 14 returns the aggregated results 18 of the operations to the application 10 (block 28). In some cases, the aggregated results 18 may simply comprise an indication of the results (i.e., successful execution, expressed in one embodiment as the absence of an error indication).

In this manner, the round-trip delay incurred over the communication channel is amortized over a plurality of operation invocations, dramatically reducing the overhead, as compared to the application 10 directly invoking each operation on the platform 12. Indeed, if the latency between the remote execution agent 14 and the platform 12 and the overhead of interpreting the invocation control directives is a small compared to that imposed by the communication channel, and if the bit-rate capacity of the communication channel is not the limiting factor, the overhead of executing n instructions according to the present invention is reduced by a factor of nearly n, as compared to invoking the n instructions independently.

In one embodiment, an operation invoked and executed on the platform 12 returns an indication of success or failure in executing the operation. An operation may additionally return results, such as textual, numeric, and/or logical values. In one embodiment, the fact that an operation returns one or more results is itself an indication of successful execution. The values returned by one or more operations as results may be passed as parameters to other operations. In one embodiment, the remote execution agent 14 responds to a failed operation by aborting the processing of remaining invocation control directives, thus avoiding potential invocation of operations using invalid results as parameters.

In one embodiment, the invocation control directives include conditional operation invocation directives. In this embodiment, an operation may be conditionally invoked for execution on the platform 12, such as in response to a value returned by a previously executed operation. This allows for the conditional invocation of operations based on conditions other than the execution failure of a prior operation.

The invocation control directives are described herein with reference to a virtual stack machine architecture, and zero-address virtual instructions operating on the stack. Those of skill in the art will readily recognize that, in other embodiments, the invocation control directives may assume other representations, such as for example a three-address code (also known as register transfer instructions), a data-flow graph, a state machine, a decision diagram, or the like.

As known in the art, a stack is a virtual data structure organized as an unlimited-depth buffer having a single entry/exit point. Data are written, or “pushed”, onto the stack by writing values to the “top” of the stack; previously pushed data move “down” one location in the data structure, maintaining the same order. Data are read, or “popped” from the stack by retrieving the value at the “top” of the stack; previously pushed data move “up” one location in the data structure, again in the same order. A stack is known in the computing arts as data structure particularly suitable for passing parameters between invocations of software modules, or operations.

The remote execution agent 14 maintains a stack, the data storage locations of which are of a uniform size, referred to herein as a “unit” of data. A unit may be, e.g., a word (32 bits), halfword (16 bits), doubleword (64 bits), or the like, as required or desired for a given implementation. Data smaller than a unit (as defined for a given implementation) may be automatically sign-extended, zero-padded, or otherwise filled out to a unit size prior as part of a stack push operation. In one embodiment, the memory storing the data resides on the platform 12, with the remote execution agent 14 managing the memory to implement the virtual stack architecture.

The remote execution agent 14 receives a plurality of invocation control directives 16 from an application 10, executes the directives by invoking operations to be executed by the platform 12 (and optionally ancillary data manipulation), collects the results returned by executed operations, and returns an aggregation of the results 18 to the application 10. The remote execution agent 14 has no knowledge of the actual operations executed by the platform 12, other than their identifiers and parameters. The remote execution agent 14 may thus provide an application 10 with a means to remotely invoke inter-dependent operations from any set of operations that can be accessed via Remote Open Platform API (rOPA) technology, or other protocols for remote execution, such as Distributed Component Object Model (DCOM), Symbol Object Access Protocol (SOAP), Common Object Request Broker Architecture (CORBA), or the like. An exemplary set of invocation control directives is presented.

Invoke M, N invokes an operation for execution on the platform 12. The directive pops information about a receiver object and N arguments from the stack, directs the platform 12 to execute the method with identity M in the indicated interface, and pushes the result on the stack. In one embodiment, the receiver object is a Component Object Module (COM) or Ericsson Component Model (ECM) interface pointer and M is a method index (referencing a virtual table entry). In this embodiment, an arbitrary Open Platform API method may be invoked.

Check pops a value off the stack and inspects it. If the popped value indicates an error, the last operation invoked is considered to have failed. The error indication may comprise a dedicated error bit, a logical value, or the like.

Read N pops an address off the stack, reads N bytes of data beginning at the indicated address, and then pushes the data onto the stack.

Store N pops an address and N bytes from the stack, and then writes the data to the indicated memory address.

Push V pushes a (constant) value V onto the stack.

Dup N duplicates the value at offset N of the stack by pushing it onto the top of the stack. Offset 0 is the stack top, offset 1 is the next element on the stack, and so forth.

Alloc N allocates N bytes of memory from generally available memory (such as on the platform 12), known in the art as the “heap,” and pushes the address of the allocated storage on the stack. The allocation may fail if the heap is exhausted.

Dealloc pops an address and de-allocates storage associated with the address, returning it to the heap.

Operation of the remote execution agent 14 using these invocation control directives is described with the following example of an application 10 reading the status of a battery on a platform 12, such as a mobile telephone. Using an OPA interface, the following operations must be executed:

Download two UUID (128-bit identity data) values to the platform 12, identifying the IBatteryDeviceManager interface and the CBatterDeviceManager component.

Create an IBatteryDeviceManager instance using the IShell::CreateInstance interface, passing pointers to the downloaded UUID instances as arguments.

Create an IBatteryDevice instance by calling IBatteryDeviceManager::OpenBatteryDevice, passing the interface pointer obtained in the previous step.

Invoke and execute the IBatteryDevice::GetRemainingCapacityInPercent operation, passing the interface pointer obtained in the previous step and receiving the battery status as a result.

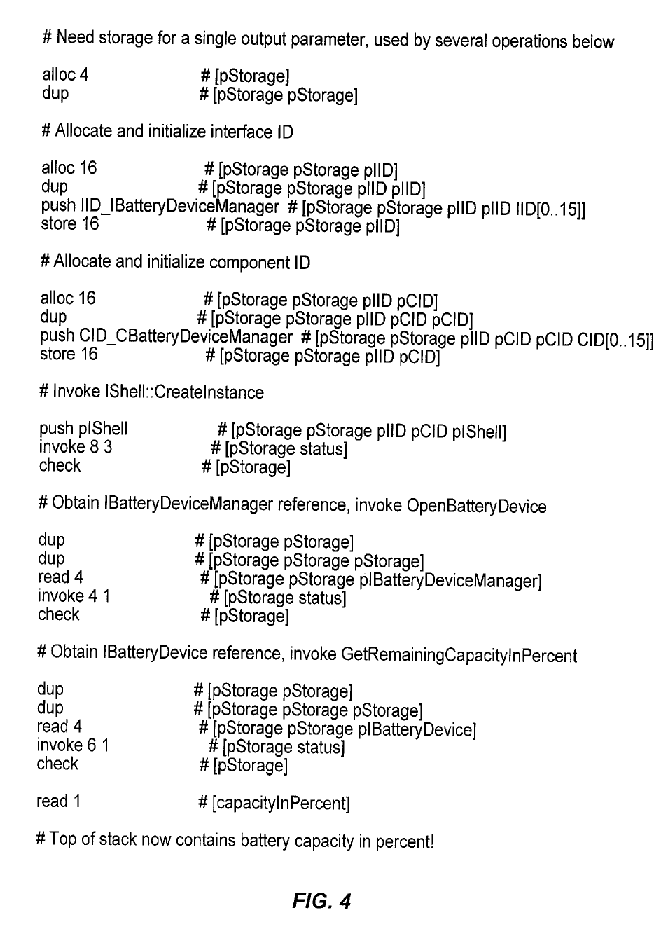

Prior art systems and methods require the application 10 to send a separate message to the platform 12 requesting each of these operations, and wait for a response before proceeding to request the next operation (assuming no errors or failures). This approach incurs the penalty of a round-trip delay for each request. According to one embodiment of the present invention, the above-defined invocation control directives are employed by the application 10 to invoke the operations for execution on the platform 12 with only two messages: a plurality of invocation control directives 16 sent to the remote execution agent 14 and the aggregated results 18 returned by the remote execution agent 14. The plurality of invocation control directives 16 to accomplish this task is depicted in FIG. 4, with the state of the stack, as each directive is executed, in comments (wherein the top of the stack is to the right). Invocation control directives to deallocate memory are omitted for clarity.

If an alloc or check operation fails, the sequence 16 is aborted. In this case, the index (0,1,2, . . . ) of the failed operation is returned with the contents of the stack in the aggregated results 18, which are returned to the application 10. Upon successful termination, the remote execution agent 14 returns the index N (number of invocation control directives in the plurality 16). In this way, the application 10 can correctly interpret the stack contents.

In one embodiment, the invocation control directives include constructs allowing for the conditional invocation of operations—that is, not limited to the success/failure of an operation, but also including general conditions consisting of the values returned by previously executed operations. By generalizing the conditions that can be tested by the invocation control directives, and by adding conditional branch instructions, the execution of the invocation control directives can proceed along different paths depending on the outcome of the tests. Representative invocation control directives related to conditional execution are presented.

The directives Equal, LessThan, and GreaterThan each pop two values off the stack and compare them. The directives then push a logical TRUE indicator onto the stack if the first value has the respective relation to the second value, or push a logical FALSE indicator onto the stack otherwise. As well known in the art, TRUE may be represented by one (or any non-zero value) and FALSE may be represented by zero (or vice versa).

IsZero pops a value off the stack, and pushes an indicator of its logical complement onto the stack. Note that this directive is equivalent to Push 0 followed by Equal. The combination of Equal, LessThan and GreaterThan with IsZero allows the relations “not equal,” “greater than or equal,” and “less than or equal” to be expressed and evaluated.

BranchTrue Destination pops one value off the stack and examines it. If the value is a logical TRUE indicator, the remote execution agent 14 proceeds to process the invocation control directive referenced as “Destination” within the plurality of invocation control directives 16. If the popped value is a logical FALSE indicator, the remote execution agent 14 proceeds to process the next invocation control directive following the BranchTrue directive. Transferring execution to the end of the plurality of invocation control directives 16 (i.e. index N if there are N invocation control directives in the plurality 16) causes execution to terminate.

Goto Destination results in an unconditional transfer of execution to the Destination offset within the plurality of invocation control directives 16. Goto does not affect the stack.

In one embodiment, the invocation control directives include arithmetical operators, such as add, sub, bitwise-and, bitwise-or and shift. These allow for more complex condition expression for conditional invocation and branching, and also allow for more complex computation of arguments to be passed to operations by Invoke. Their implementation and effect on the stack are straightforward to those of skill in the art.

The stack-based structure, and the invocation control directives described above allow for the creation of a simple API on the application 10. Such an API would provide a standard interface to an application programmer, while hiding the details of operation. Similarly, the remote execution agent 14 may invoke any set of operations for execution on the platform 12 that conform to a COM-like model.

Embodiments of the present invention significantly reduce per-message overhead in remote operation invocation, by combining multiple invocation requests into a single sequence 16 that expresses inter-dependencies between the operations, and a single response 18. The remote execution agent 14 is a simple interpreter, consuming few platform 12 resources. It is simple to implement and test, and has minimal impact on execution time, memory management, or power consumption.

The remote execution agent 14 may be implemented as a state machine in hardware or programmable logic, or may be implemented as software executing on a processor or Digital Signal Processor (DSP), or any combination thereof.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of invoking a plurality of operations on a platform by a remote execution agent, under the direction of a remote application, wherein communications between the application and platform incur a round-trip delay, comprising:
receiving a plurality of invocation control directives from the application;
invoking a plurality of operations for execution on the platform in response to the invocation control directives;
returning at least an indication of the results of the operations to the application.

2. The method of claim 1 wherein a first operation generates a first result, and wherein a second operation after the first operation uses the first result as a parameter.

3. The method of claim 2 further comprising:
monitoring the results of each operation; and
if the first operation indicates an error, aborting the second operation.

4. The method of claim 1 wherein invoking a plurality of operations for execution on the platform comprises invoking a first operation, and conditionally invoking a second operation after the first operation, depending on the results of the first operation.

5. The method of claim 1 wherein invoking a plurality of operations for execution on the platform comprises invoking a first operation, and then invoking either a second operation or a third operation, depending on the results of the first operation, and continuing operation invocation following the selected second or third operation.

6. The method of claim 1 wherein the remote execution agent implements a stack-based virtual machine, and wherein the plurality of invocation control directives comprises a plurality of zero-address virtual instructions.

7. The method of claim 6 wherein the plurality of invocation control directives includes an “Invoke M, N” directive operative to cause the remote execution agent to
invoke an identified operation M for execution on the platform;
pop a specified number N of arguments from a stack and pass them to the operation M; and
push the results of the operation M onto the stack.

8. The method of claim 6 wherein the plurality of invocation control directives includes a “Check” directive operative to cause the remote execution agent to pop the top value of a stack and examine it for an error indication.

9. The method of claim 6 wherein the plurality of invocation control directives includes a “Read N” directive operative to cause the remote execution agent to
pop an address from the top of a stack;
read N units of data from memory on the platform; and
push the N units of data onto the stack.

10. The method of claim 6 wherein the plurality of invocation control directives includes a “Store N” directive operative to cause the remote execution agent to
pop an address from the top of a stack;
pop N units of data from the stack; and
write the N units of data to memory on the platform, beginning at the address.

11. The method of claim 6 wherein the plurality of invocation control directives includes a “Push V” directive operative to cause the remote execution agent to push the value V onto the stack.

12. The method of claim 6 wherein the plurality of invocation control directives includes a “Dup N” directive operative to cause the remote execution agent to duplicate the value at offset N of the stack by pushing it onto the top of the stack, where offset N=0 identifies the top of the stack.

13. The method of claim 6 wherein the plurality of invocation control directives includes an “Alloc N” directive operative to cause the remote execution agent to allocate N units of data on the platform, and push the beginning address of the allocated memory onto the stack.

14. The method of claim 13 wherein the plurality of invocation control directives includes a “Dealloc” directive operative to cause the remote execution agent to pop an address from the top of the stack and de-allocate memory on the platform beginning with that address.

15. The method of claim 6 wherein the plurality of invocation control directives includes an “Equal” directive operative to cause the remote execution agent to
pop two values from the top of a stack;
compare the two values; and
if the values are equal, push a logical TRUE indicator onto the stack; or
if the values are not equal, push a logical FALSE indicator onto the stack.

16. The method of claim 6 wherein the plurality of invocation control directives includes a “LessThan” directive operative to cause the remote execution agent to
pop first and second values from the top of a stack;
compare the two values; and
if the first value is less than the second value, push a logical TRUE indicator onto the stack; or
if the first value is not less than the second value, push a logical FALSE indicator onto the stack.

17. The method of claim 6 wherein the plurality of invocation control directives includes a “GreaterThan” directive operative to cause the remote execution agent to
pop first and second values from the top of a stack;
compare the two values; and
if the first value is greater than the second value, push a logical TRUE indicator onto the stack; or
if the first value is not greater than the second value, push a logical FALSE indicator onto the stack.

18. The method of claim 6 wherein the plurality of invocation control directives includes an “IsZero” directive operative to cause the remote execution agent to
pop a value from the top of a stack; and
push a logical indicator onto the stack that is the logical compliment of value popped from the stack.

19. The method of claim 6 wherein the plurality of invocation control directives includes a “BranchTrue Destination” directive operative to cause the remote execution agent to
pop a value from the top of a stack;
if the value is a logical TRUE indicator, proceed to execute the invocation control directive referenced as “Destination” within the plurality of invocation control directives; and
if the value is a logical FALSE indicator, proceed to execute the next invocation control directive following the BranchTrue directive.

20. The method of claim 6 wherein the plurality of invocation control directives includes a “GoTo Destination” directive operative to cause the remote execution agent to proceed to execute the invocation control directive referenced as “Destination” within the plurality of invocation control directives.

21. The method of claim 1 wherein the plurality of invocation control directives comprises a plurality of register transfer instructions.

22. The method of claim 1 wherein the plurality of invocation control directives comprises a plurality of data-flow graphs.

23. A computing platform, comprising:
memory;
a controller operative to execute operations; and
a remote execution agent operative to
receive a plurality of invocation control directives from a remote application;
invoke a plurality of operations for execution on the platform in response to the invocation control directives; and
return at least an indication of the results of the operations to the application.

24. The platform of claim 23, wherein the remote execution agent implements a stack data structure for passing parameters between operations.
